(19) United States
(12) Patent Application Publication
(10) Pub. No.: US 2007/0143688 A1
(43) Pub. Date: Jun. 21, 2007

(54) SYSTEM AND METHOD FOR MARK AND NAVIGATION TO FACILITATE CONTENT VIEW

(76) Inventors: Jian Hong Cheng, Beijing (CN); Yue Ma, Beijing (CN); Ying Su Rui, Beijing (CN)

Correspondence Address: IBM CORPORATION;INTELLECTUAL PROPERTY LAW, 11400 BURNET ROAD, AUSTIN, TX, 78758, US

(21) Appl. No.: 11/611,912

(22) Filed: Dec. 18, 2006

(30) Foreign Application Priority Data
Dec. 20, 2005 (CN) 200510137713.3

(51) Int. Cl. G06F 17/00

(52) U.S. Cl. 715/738

(57) ABSTRACT

Systems and methods for facilitating a user's navigation through the contents in a viewer window are disclosed. In one embodiment a method is provided comprising receiving a user request to perform a navigation of displayed contents in a viewer window; determining if the navigation is associated with a content jump following a receipt of the user request. The described method further comprises generating an index mark in response to a determination that the navigation is associated with a content jump; and storing the index mark within an index mark queue to facilitate user navigation utilizing the contents thereof.

### CROSS-REFERENCE TO RELATED APPLICATIONS

This application claims the benefit of priority of Chinese Patent Application No. 200510137713.3 filed on Dec. 20, 2005, and entitled “SYSTEM AND METHOD FOR MARK AND NAVIGATION TO FACILITATE CONTENT VIEW” hereby incorporated by reference herein for all purposes.

### BACKGROUND

1. Technical Field

The present invention relates to content navigation. More specifically, the present invention relates to a system and method for mark and navigation to facilitate the user's content view.

2. Description of Related Art

With constant development of information technology and in view of environment protection, paper is decreasingly used as much as possible while electronic documents are increasingly used. An electronic document typically has information content (such as text, graphics, and pictures) and formatting information, which directs how the content is to be displayed. In addition, with recent advances in multimedia technology, electronic documents can now also include sound, full motion video, and other multimedia content.

Generally speaking, a body of content may be too large to be displayed in its entirety on a display monitor at a usable size. So applications typically display only a portion (or fragment, subset) of the content and allow the user to navigate incrementally through the content one portion at a time.

In order to allow users to navigate through the content, applications typically provide a variety of techniques to enable users to indicate which portion of content to be displayed. For example, in a typical word processing context, the application, in response to user input, can “scroll” a document by showing the old content portion moving off the display in a smooth, continuous motion as a new content portion moves onto the display. Another method of displaying new portions of content is by using “paging”. In this case, the application jumps to and displays the new portion of the content, replacing the old portion on the display monitor without any intermediate display states.

Common navigation mechanisms will be explained below.

Some navigation mechanisms are realized by the use of a keyboard. For example, the arrow keys typically indicate that the application should display a portion of the content overlapping the currently displayed portion of content and located in the direction indicated by the used arrow. Similarly, the “Page Up” and “Page Down” keys indicate that the application should display a portion of content adjacent to the current portion and located in the indicated direction (i.e., upward or downward).

Other navigation mechanisms are realized by a graphical user interface. Also known as “widgets”, these mechanisms are user interface controls that can be manipulated by the users, typically using a mouse or touchpad. A “widget” is an element of a graphical user interface that displays information or provides a specific way for a user to interact with the operation system and applications. For example, a scrollbar is a graphical widget that can be used to navigate in a single dimension (typically in the vertical or horizontal dimension) through a document.

In addition, commands, whether selected from a menu or entered using a keyboard, also may be used to navigate through a document. For example, the “Find” command available in many word processing applications makes it possible for a user to navigate through a document by viewing the content portions surrounding a text to be found. Other commands may allow users to navigate in other ways. And also, commands may be invoked through the use of keystrokes, menus, graphical widgets, or a command line.

Whatever navigating method is used, the users may encounter the following case when browsing an electronic document. In this case, the users do not always sequentially view the electronic document but typically touch upon only the essentials of overall content in the document from beginning to end. In this course, some contents may naturally be passed, and then the users need navigate back to the passed contents for careful reading and viewing. Actually, the passed part of contents is just the one that end users are really interested in. However, in other solutions, no special navigation means is provided for the users to return right to the previously passed content. Thus on one hand, the users often need to be careful whether a target position is reached in the returning course; and on the other hand, if the users want to navigate back to a specified position, which is far away from the current one, the users need to pass through many intermediate portions (or views) to reach the target position.

In other solutions, applications mechanically record each of the displayed views in the user's browsing sequence, no check mechanism being provided to distinguish or filter the portions of content that the users have not browsed. Hence if the users want to navigate back to the previously passed portion of contents, they need to navigate unnecessarily through many other portions. So it is very inconvenient for the users. When utilizing a text editor, a presentation editor or a web browser, etc. to view the contents, the users may encounter the above case.

Furthermore, the above case occurs not only during the user's browsing text contents but also during listening to audio contents and viewing video contents and the like. For example, in the course of viewing the video contents, the users pass a portion of contents by using a time slider. The users usually do not remember the currently play time of the video when performing the sliding operation, so if they later hope to navigate back to the previous portion, it is hard for them to return to the precise position of the video.

### BRIEF SUMMARY

Embodiments of the present invention provide systems and methods for facilitating user's navigation through the contents in a viewer window. In one embodiment a method is provided comprising receiving a user request to perform a navigation of displayed contents in a viewer window; determining if the navigation is associated with a content jump following a receipt of the user request. The described method further comprises generating an index mark in response to a determination that the navigation is associated with a content jump; and storing the index mark within an index mark queue to facilitate user navigation utilizing the contents thereof.

According to various embodiments of the present invention, each time a user performs an operation (whether to a window or to the contents) while viewing displayed contents, it is determined whether the operation causes a content jump from the displayed contents of the previously displayed view to those of the current view to be displayed before the operation (that is, whether the displayed contents of the new and old views are contiguous or some intermediate contents are bypassed by the operation). When a such a “content jump” is determined to have occurred, an index mark is generated for the old view and stored into an index mark queue, so that the users can easily navigate through the displayed contents utilizing the index mark queue and the index marks stored therein.

During browsing the contents, exemplary cases in which a content jump may occur include but are not limited to the where 1) a user utilizes command navigation, (e.g., “Find”, “Replace”, “Go to”, “Fast Forward”, “Fast Backward”, or the like) 2) a user utilizes GUI widgets navigation, such as a “Scrollbar”, “Slider” or the like 3) a user utilizes index navigation, (e.g., an “Index”) and 4) a user utilizes map navigation such as “Document Map”, “Table of Contents” or the like.

### BRIEF DESCRIPTION OF THE DRAWINGS

It is believed that the above features, advantages and purposes of the invention will be better understood from the following description of the preferred embodiments of the invention taken in conjunction with the accompany drawings, in which:

FIG. 1 is an overall flow chart of a method according to an embodiment of the present invention;

FIG. 2 is an overall block diagram of a system according to an embodiment of the present invention;

FIG. 2A is a block diagram of a system according to the modes for carrying out an embodiment of the present invention;

FIG. 3 is a flow chart of specific operations for checking whether a user's operation causes a change of view according to an embodiment of the present invention;

FIG. 4 is a flow chart of operations for determining whether a content jump occurs according to an embodiment of the present invention;

FIG. 5 is a flow chart of specific operations for generating and storing an index mark shown in FIG. 1 according to an embodiment of the present invention;

FIGS. 5A and 5B are flow charts of operations performed by an index mark manager according to different storage strategies within one or more embodiments of the present invention;

FIG. 6 is a flow chart of operations for utilizing an index mark for navigation according to an embodiment of the present invention;

FIGS. 7A-7F are GUI examples illustrating use of systems and methods according to one or more embodiments of the present invention;

FIG. 8 is a flow chart of operations in which a new view generates a new content range according to an embodiment of the present invention; and

FIG. 9 is a schematic view associated with a visual indication according to one or more embodiments of the present invention.

The use of the same or similar reference symbols within the accompanying drawings is intended to indicate similar or identical items.

### DETAILED DESCRIPTION OF ILLUSTRATIVE EMBODIMENTS

Before the illustrated embodiments of the present invention are described, the terminology used in the present invention is first explained.

The term “content” herein encompasses a wide variety of information including text, images, web pages, multimedia presentation, virtual worlds, interactive sessions, or any combination thereof.

A “portion” as used herein is a range for place-holding in the content formatting course. Taking text contents as an example, a text portion is a text range containing a uniform piece of information that appears within the text flow. For example, a portion can be a paragraph formatted in a uniform manner; or if a paragraph comprises a plurality of different special formats (for example, color, word size, and font), the text of each of the special formats is a text portion.

In the descriptions below, without clear indication, the term “portion” should be understood as the one having a specified meaning as indicated here; whereas in the case where its ordinary meaning is used, for example, regarding the word “portion” in the expression “a portion of content”, it will be replaced with the terms such as “fragment” or “subset” and so on.

A “viewer” as used herein is a window for viewing content included in a graphical user interface (GUI) that is provided by application programs. The windowed GUI has a viewing area on the computer display screen. The windows are managed by a window manager that allows windows to be stretched on any side, minimized, maximized, and closed using graphical controls. A viewer window according to the present invention can be the one associated with a variety of contents adapted to the present invention, comprising but not limited to: a text editor window, a form editor window, a presentation editor window, an audio/video player window, a graphical file display window, a web browser, etc.

An “old view” as used herein means a previous view. By contrast, a “new view” as used herein is intended to indicate the current view.

“Old content” as used herein means content that is displayed in an “old view” and, similarly, “new content” as used herein is intended to indicate content displayed in the “new view”.

A “logical coordinate” as used herein represents the positions of portions of the content and the sizes of the visual areas of the viewer. It is independent of the physical positions and platform and is convertible with a pixel coordinate.

In the present invention, for convenience, the top left logical coordinate of the visual area of the viewer window is supposed to be zero, and the position of the displayed portion of content is relative to the top left coordinate of the visual area of the viewer window.

The “range of content” is used herein to mark the position and boundary of a view. It may comprise a visual indication that defines the current, previous and next view with respect to the size of the current view and may further comprise page number, portion, display ratio, frame/chapter (in terms of video contents), etc.

A “content range set” is used herein to store ranges of content. Upon detecting the change of the size of the view, the content range set will be updated. The content range is a basis for determining whether or not a content jump occurs.

An “index mark” is used within the present description for marking the passed contents, which typically has the following forms: a portion in the content that is formatted in a uniform manner, for example, a paragraph, a word, chapter headings, locations of key words and locations of text objects (such as illustrations, objects or tables) in a paragraph and the like which have a special format.

The index mark has properties for representing information to be recorded by the index mark, such as the coordinate information of the marked view, the information of the recorded portion (even including the context information of the recorded portion), the content boundary, the relative coordinate information of the portion in the view, page number, etc., and these can serve as the properties of the index mark and are recorded in the index mark. The index mark further has a name for identification and management purposes.

A “visual indication” as used herein is a pointer that can indicate the coordinate of the position, location and boundary of a specified portion (e.g., the first portion) that is displayed in the associated view, the distance of the specified portion relative to the top left of the associated view, and key words of the specified portion and the current page number. In the described embodiments of the present invention, for illustration, the visual indication is defined as a pointer to the top left of the view, but obviously, any other proper position of the view can be used as “visual indication”.

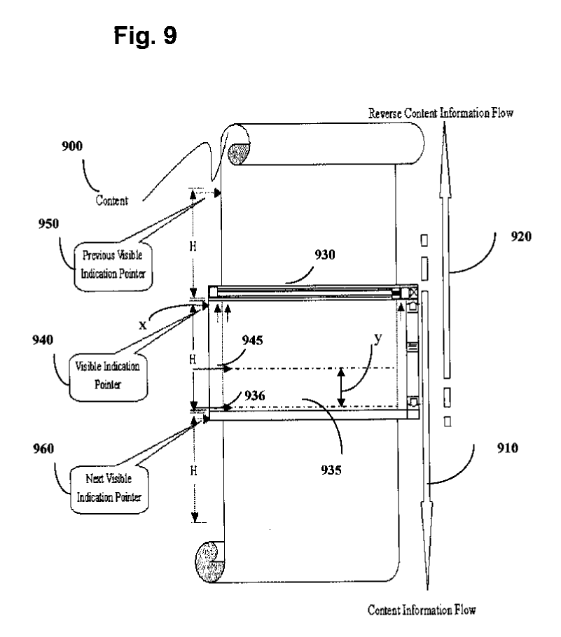

FIG. 9 is a schematic view associated with a visual indication according to one or more embodiments of the present invention. In FIG. 9, contents 900 are vividly shown similar to a picture scroll, which is displayed process blockwise in a viewer window 930 in the direction (arrow 910) of content information flow or in the direction (arrow 920) of reverse content information flow over the user's operation. As known to those skilled in the art, when displaying the contents, applications can assign a logical coordinate (the logical coordinate can be converted with a pixel coordinate) to the contents and calculate out the contents which should be displayed in each of sequential views according to the size of the visual area of the specified viewer window 930, so that it is predetermined which view should display the contents of which coordinate range. In addition, every time when the users perform an operation such as paging or scrolling to the contents or change the size of the window, the application(s) will re-calculate that information. Thus, the present invention can directly obtain from application data associated with the position of the visual indication and does not need additional computation.

In FIG. 9, the currently displayed view is a view 935, the last line of which is represented by an arrow 936. Three “visual indications” are shown: the “visual indication” 940 of the view 935, the “previous visual indication” 950 of the view previous to the view 935, and the “next visual indication” 960 of the one next to the view 935. These three visual indications 940, 950, 960 are elements constituting the content range set of the current view 935. It should be understood that, in FIG. 9, three visual indications in the vertical direction are used to represent the range of content of the view 935. However, the present invention is not limited to this, but can use the visual indications in the horizontal direction to represent the range of content as required.

The principles of the present invention are described below by referring to the drawings. It should be pointed out that, for convenient illustration, text content is taken as an example to be described; however, it is easily understandable that the present invention is not limited to the text content but is equivalently applicable to a variety of contents such as images, web pages, multimedia content, virtual worlds, interactive sessions, etc.

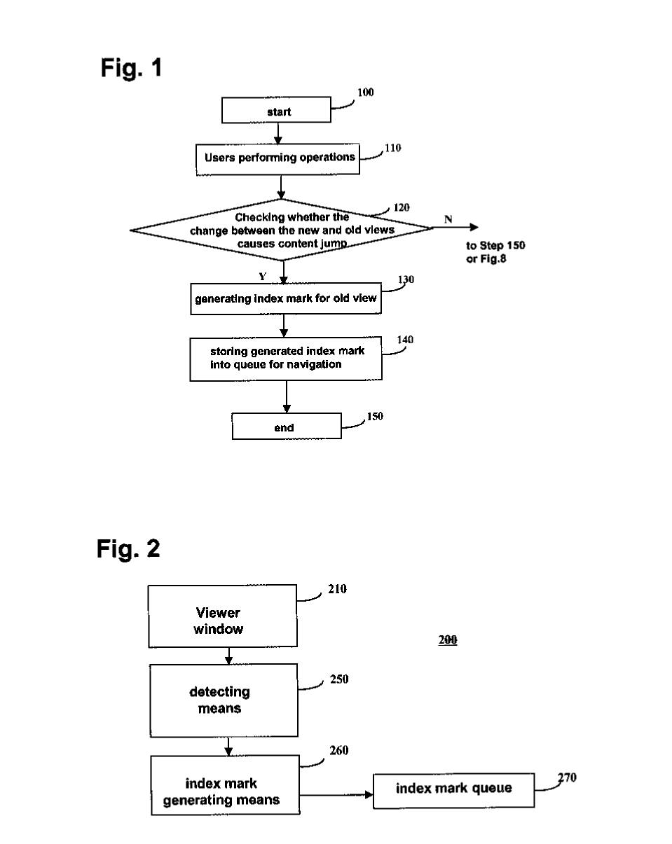

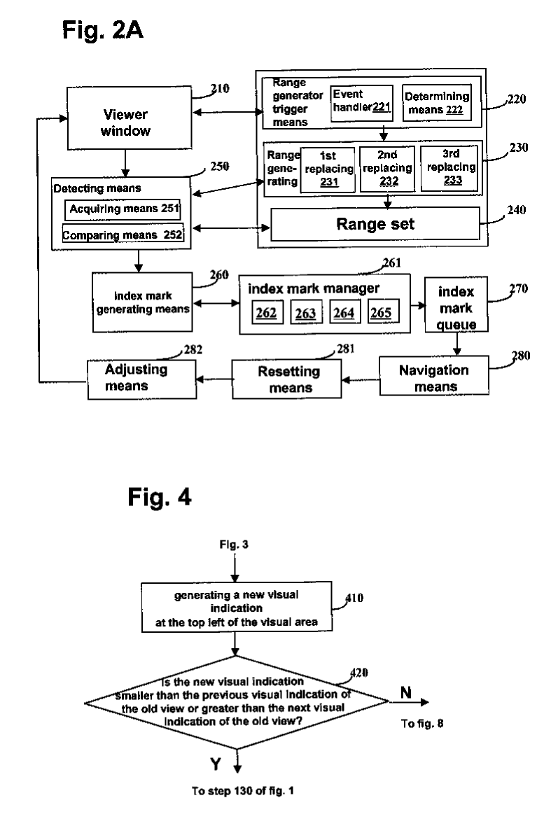

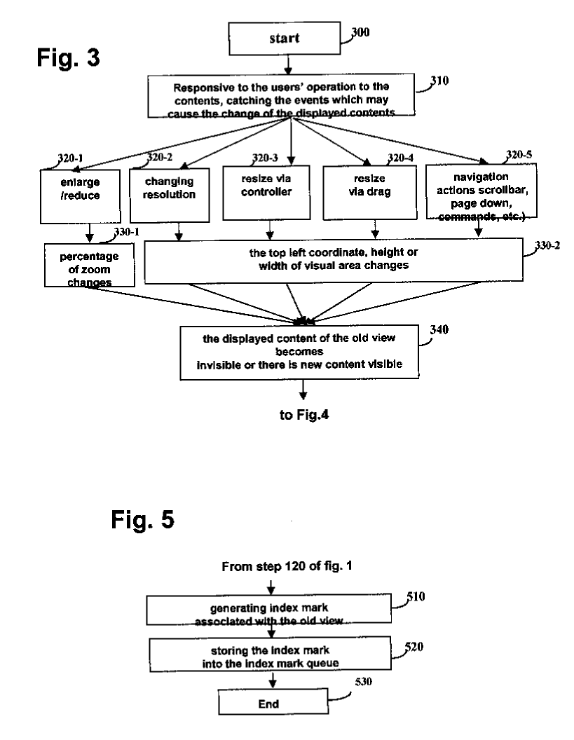

FIG. 1 is an overall flow chart of a method according to an embodiment of the present invention. The depicted method embodiment begins (process block 100), and a user performs browsing of text content through a viewer.

Next, the user performs an operation to the content or to a viewer window (process block 110). Subsequently, (process block 120) it is determined whether the user's operation can cause discontinuity between the displayed contents in the old view prior to the operation and those in the new view after the operation, that is, whether a content jump occurs.

If the content jump is determined to have occurred (“Yes” branch in process block 120), for example, the user scrolling down the content by many pages, an index mark is generated for the old view (process block 130). Subsequently, (process block 140), the generated index mark is stored into an index mark queue. By repeating the operations depicted in process blocks 110-140, it is possible to store all the generated index marks into the index mark queue during the user's viewing the content, so that the user can navigate through the content based on the index mark queue. Then, the depicted process ends (process block 150) as shown.

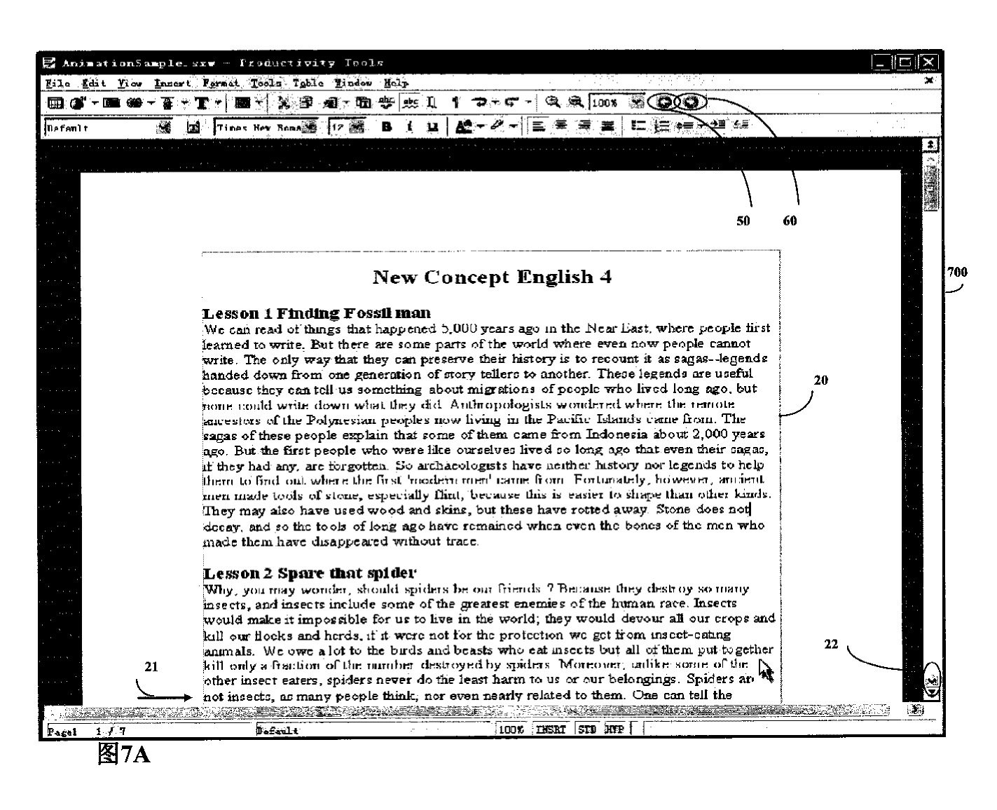

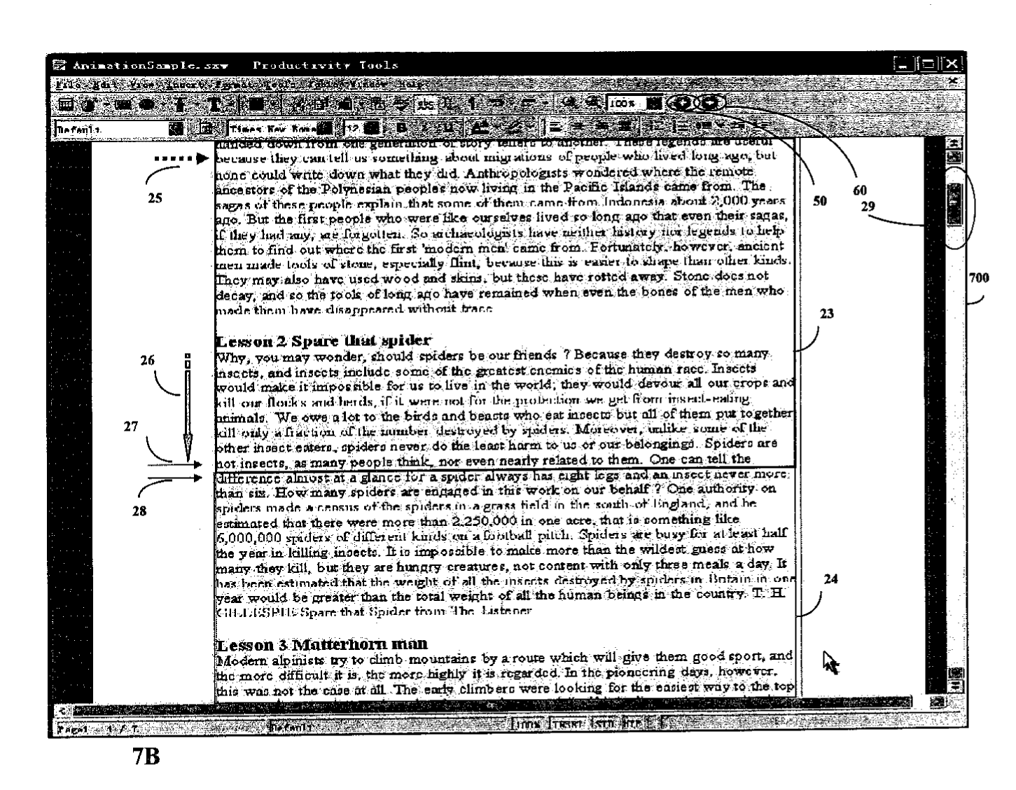

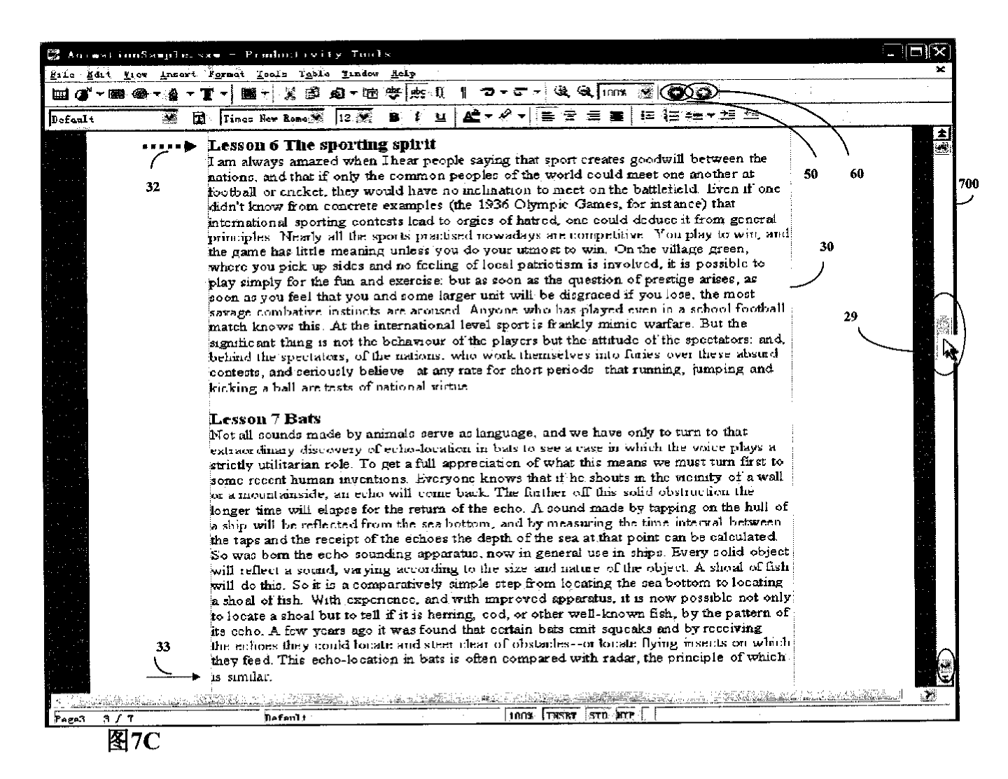

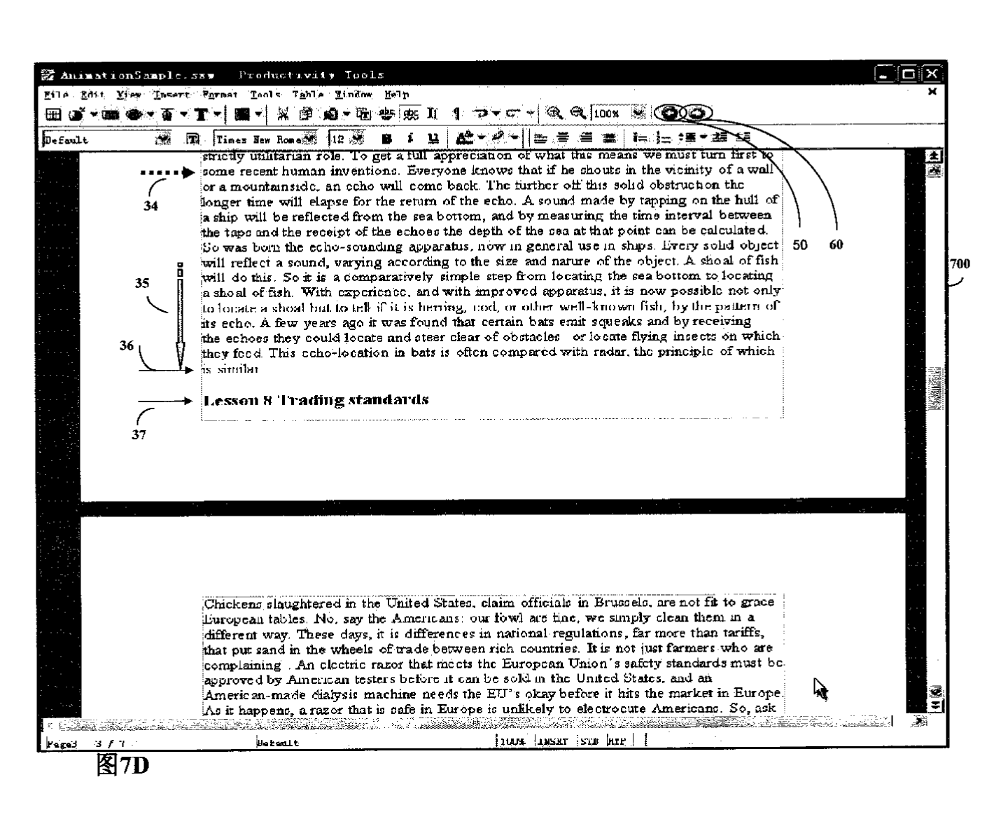

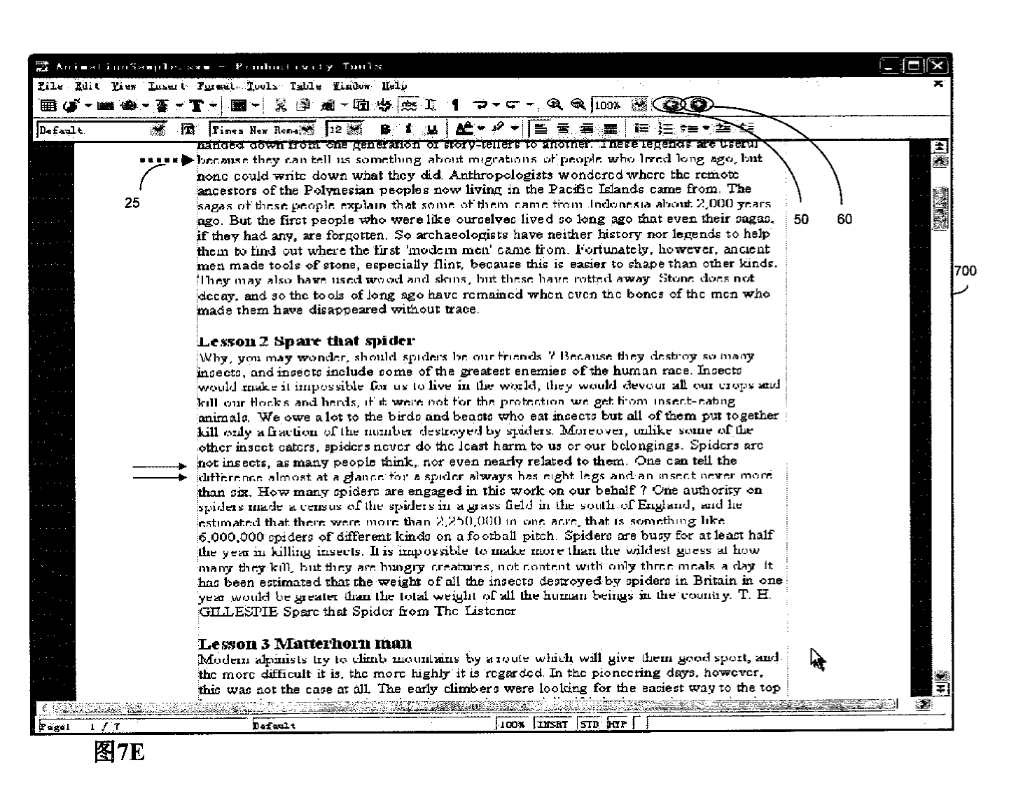

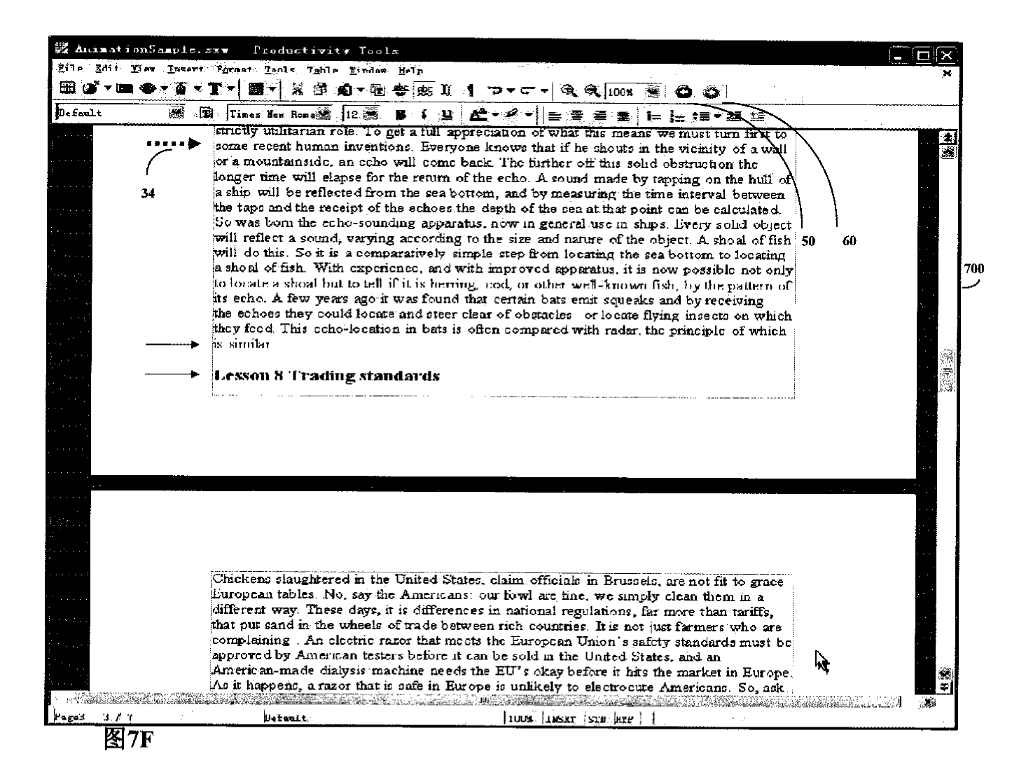

If the content jump is determined not to have occurred (“No” branch in process block 120, the illustrated method turns to the operation of generating the range of content for the newly displayed view as shown in FIG. 8 as required, or enters process block 150 to complete operation.

FIG. 2 is an overall block diagram of a system according to an embodiment of the present invention. System 200 of FIG. 2 comprises a viewer window 210, detecting means 250, index mark generating means 260, and an index mark queue 270.

The viewer window 210, as shown by a viewer window 700 in FIG. 7, has a visual area for displaying content. A user can perform various operations to the viewer window 210 and/or the contents displayed therein.

Every time a user performs operations to the viewer window 210 or its contents, detecting means 250 checks whether the displayed contents of the previous view and those of the current view are contiguous, namely, checking whether the change between the displayed contents of the new view and the old view causes a content jump.

When the detection result of the detecting means 250 shows the described change has caused a content jump, index mark generating means 260 generates an index mark for the old view.

The index mark queue 270 is utilized in one or more embodiments of the present invention to store all the generated index marks during the user's browsing the content.

By referring to FIGS. 2A and FIGS. 3-9, the method and system embodiments shown in FIGS. 1 and 2 are explained in greater detail herein below, after high-level overall flow chart and block diagram embodiments are described in connection with FIGS. 1 and 2.

FIG. 3 and FIG. 4 show specific exemplary operations performed in connection with process block 120 shown in FIG. 1.

According to one or more embodiments of the present invention, before performing an operation (process block 120) to check whether the user's operation causes the content jump, a check is first performed to determine whether the user's operation causes a change of the displayed contents of the new view and the old view. This action is typically realized by capturing some events which may result in a change of the displayed contents of the views.

In the embodiment of FIG. 3, an illustrated process begins (process block 300), in which a user is viewing content in a viewer window. Thereafter, (process block 310), during the user's viewing of content and as the user performs operations to the contents and/or to the viewer window, range generator trigger means 220 catches operations (or events) which may result in the change of the displayed contents of the current view.

The events caught by range generator trigger means 220 comprise items represented by signs 320-1 to 320-5, i.e., whether the user enlarges/reduces (320-1) the contents, whether the display resolution is changed (320-2), whether the size of the view is changed by using a controller (320-3), whether the size of the view is changed via drag-and-drop (320-4), and whether navigation operations are performed by, for example scrolling, paging, keyboard, scrollbar and commands, etc. (320-5). The given examples of the user's operations which may result in the change of the displayed contents are not exhaustive but can further comprise other examples. For example, in terms of the applications allowing the user to set the size of the view, the range generator trigger means 220 can further catch whether the user re-set the size of the view.

If the event 320-1 occurs, the display ratio of the view is caused to change (block 330-1); and if the events 320-2 to 320-5 occur, the top left coordinate, height or width of the view changes (block 330-2).

Once any of the events 320-1 to 320-5 occur, the process shown in FIG. 3 performs an operation to determine the change of the displayed content in the view, so that the operations shown in FIG. 4 can be further performed (process block 340). Otherwise, the process returns (process block 310) to waiting to catch the new user's operations. Since at this time no difference exists between the new and old views, a content jump cannot occur. Therefore, corresponding to the “No” branch at process block 120 as shown in FIG. 1, the depicted process concludes (process block 150).

The present invention provides range generator trigger means 220 and range generating means 230, as shown in FIG. 2A. Range generator trigger means 220 is utilized in the illustrated embodiment to check whether there is a change between the displayed contents in the old view and those in the new view before operations are performed, for example, whether there are new contents visible and old contents invisible. If a change is detected, it is necessary to invoke range generating means 230 for generating a new range of content for the new view so as to invoke range generating means 230, as described below.

Moreover, range generator trigger means 220 can further comprise an event handler 221 and determining means 222, as shown in FIG. 2A. The event handler 221 is utilized in one or more embodiments to capture, for example, events represented by signs 320-1 to 320-5 and to notify determining means 222. Determining means 222 is similarly utilized to determine, after event handler 221 catches such events, whether a user's operation has caused a change of the displayed contents in the view so as to trigger subsequent operations.

FIG. 4 is a flow chart of operations for determining whether a content jump occurs according to an embodiment of the present invention. When a user's operation is determined to have caused a change of displayed contents using the process embodiment shown in FIG. 3, detecting means 250 determines whether such a change has caused a content jump using the process embodiment of FIG. 4. According to the illustrated embodiment, such a determination is executed based on a visual indication in the content range set.

The method embodiment shown in FIG. 4 follows the above-described operations as illustrated and described in connection with FIG. 3 and subsequently begins (process block 410). Since a user's operation at this point of operation has caused a difference between the displayed contents in the new view and those in the old view, associated applications will re-calculate the coordinate, boundary and other information of the new view. Thus, detecting means 250 obtains from the applications the calculated top left coordinate of the new view as a visual indication of the new view.

Subsequently, (process block 420) detecting means 250 compares the visual indication of the new view with the previous visual indication and the next visual indication of the old view to determine whether the visual indication of the new view is smaller than the previous visual indication of the old view or greater than the next visual indication of the old view, so as to determine whether certain contents are passed.

Referring to the exemplary embodiment of FIG. 9, where a view 935 is the currently displayed view, the last line thereof is marked by an arrow 936, the current coordinate of the top left (i.e., the place of a visual indication) is x, and then a user performs an operation to view 935 in the direction of content information flow 910. If the operation is to move downwards within view 935 so that the last line thereof is moved from the position of sign 936 to that of sign 945 (where the height there-between is y), at this time the displayed contents change. Thus, a new visual indication is generated relative to the top left of the new view with coordinate is x+y. In this case, the coordinate at the place of the new visual indication is greater than the original visual indication 940 (the coordinate x) of old view 935 but smaller than the original next visual indication 960 (the coordinate x+H) of old view 935, so the displayed contents are consecutive and no content is passed. If a user's operation is paging down the contents by 1 page, then the new visual indication of the new view is just the coordinate (x+H) of original next visual indication 960 of old view 935, so the new view and the old one are also consecutive and no content is passed. If paging down the contents by two or more pages (the coordinate x+nH, n representing the paging down number, n≧2), the pointer of the new view exceeds a next visual indication 960 of old view 935 so as to determine there are passed contents. The operations in the direction of reverse content information flow are similar to the above and therefore will not be described in greater detail herein.

If it is determined that there are passed contents (process block 420), operations (e.g., of process block 130) are continued. Otherwise, (that is, where there is a change between the new view and the old one but no content jump occurs), operations are performed as will be described and illustrated in connection with FIG. 8.

In addition, detecting means 250 comprises acquiring means 251 and comparing means 252, as shown in FIG. 2A. Acquiring means 251 is utilized in one or more embodiments of the present invention for, responsive to determining a change of view using determining means 222 of range generator trigger means 220, obtaining from applications the calculated top left coordinate of the new view as a visual indication of the new view. Comparing means 252 is utilized in the described embodiment to determine, by referring to the content range set of the old view, whether the visual indication of the new view is smaller than the previous visual indication of the old view or greater than the next visual indication of the old view.

Using a visual indication as a basis to determine whether a content jump occurs as shown in FIG. 4 is only one technique which may be utilized in various embodiments of the present invention. Other information (e.g., portion of the content, page number of the content, etc.) stored in the content range set is used as a basis for performing such a determination in other embodiments of the present invention.

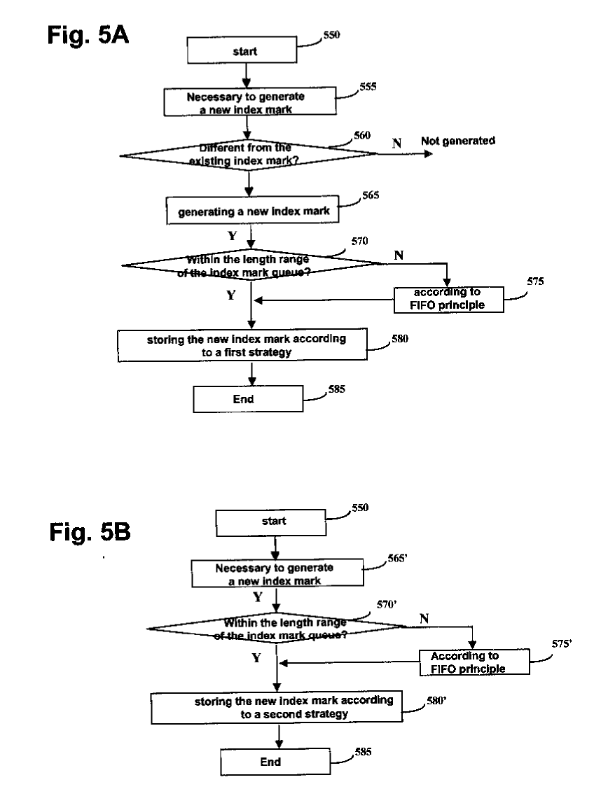

FIG. 5 is a flow chart of specific operations for generating and storing an index mark shown and described herein (e.g., as illustrated in process blocks 130 and 140 in FIG. 1, respectively) according to an embodiment of the present invention. The depicted process embodiments follows a “Yes” branch of process block 120 in FIG. 1, namely, the user's operation causing passed contents, so the passed contents are marked. Accordingly, the depicted process begins (process block 510), in which index mark generating means 260 generates an index mark for the old view.

In various embodiments of the present invention, an index mark can take a wide variety of forms. An index mark can, for example, be a certain position of the view, simply using the position of the visual indication of the old view as an index mark and using the relative coordinate or absolute coordinate of the position to represent an index mark. The index mark can similarly be a portion of the content, for example, the portion of the content displayed at the top left of the view, where the index mark is identified by recording the pointer directed to the portion or a serial number of the portion. In addition, as to the applications of the document filling type, a page number can be used to identify an index mark. The examples concerning the techniques by which an index mark may be identified in embodiments of the present invention are not exhaustive, but rather illustrative, and various other index marks are contemplated by alternative embodiments of the present invention.

A pointer is used to point to an index mark, and said pointer can be identified using the properties of the index mark. As aforesaid, the index mark can comprise one or more of the following properties: the coordinate information of the marked view, the information of the recorded portion (even the context information of the recorded portion), the content boundary, the relative coordinate information and page number of the portion in the view. Therefore, all the above information can be used to identify the pointer directed to the index mark.

After an index mark is generated (process block 510) the index mark is stored into an index mark queue (process block 520). Since the index mark queue may contain a plurality of index marks, each of the index marks can be assigned a name or a serial number so as to be conveniently identified and managed. The process shown in FIG. 5 ends (process block 530).

In the course of generating and storing index marks, the present invention can provide an index mark manager 261, as shown in FIG. 2A, for managing the addition, deletion of index marks and the length of the index mark queue, etc. The following two exemplary cases can be considered:

In a first case, a pointer P points to a currently backspaced-to index mark M (i.e., a certain index mark M backspaced to in the middle of the queue) and the user performs one more jump (not realized by the index mark navigation provided by the present invention) to a certain view 1. At this time, the view marked by the index mark M pointed to by the above pointer P is not re-marked. Then, the user performs another jump and there is content passed, and at this time the view 1 should be marked and the corresponding index 1 is established. Here, how the index mark 1 is added to the queue and how the pointer P in the queue moves should abide by the following strategy (Strategy 1): comparing the relative positional relationship between the view 1 and views marked by other index marks in the queue to determine where the index mark 1 should be inserted, and P then points to the new index mark. When using this strategy, the storing sequence of the index marks is consistent with the sequence of the text content.

In a second case, a pointer P points to the currently backspaced-to index mark M (i.e., a certain index mark M backspaced to in the middle of the queue) and the user performs one more jump (not realized by the index mark navigation provided by the present invention) to a certain view 1. At this time, the view marked by the index mark M pointed to by the above pointer P is re-marked, and the newly generated index mark M′ is stored into the end of the queue. Then, the user performs another jump and there is content passed, and at this time the view 1 should be marked and the corresponding index mark 1 is established. Here, the index mark 1 will be arranged after the above index mark M′ and becomes a new end of the queue. According to this strategy (Strategy 2), the storing sequence of the index marks is consistent with the sequence in which the user browses a document.

With respect to the first exemplary case, the operations by the index mark generator are as shown in FIG. 5A. The process shown in FIG. 5A utilizes the first strategy, and to enable the storing sequence of the index marks to be consistent with the sequence of the text content, only the entirely new index mark is stored and its storage position should be considered. The operations shown in FIG. 5A begin (process block 550) and thereafter, since there are passed contents, it is necessary to generate a new index mark (process block 555). As illustrated by process block 560, it is next determined whether the newly generated index mark is different from the existing ones in the index mark queue, which can be realized by comparing the properties (e.g., the coordinate position, portion or page number, etc.) of the index marks. If “yes”, that is, if a determination is made that this is an entirely new index mark, then a new index mark is generated (process block 565); otherwise, a new index mark is not generated.

Subsequently, it is determined whether this mark is stored within the length range of the index mark queue (process block 570). If “yes”, the index mark manager will store the newly generated index mark according to the first strategy (process block 580); otherwise, the index mark manager will first take the FIFO principle into consideration (process block 575) and then store the newly generated index mark according to the first strategy (process block 580). After the index mark is stored, the process shown in FIG. 5A ends (process block 585).

To realize the above operations, index mark manager 262 can further comprise: first determining means 262 for determining whether said newly generated index mark is different from the existing ones in the index mark queue; if different, index mark generating means 260 is invoked to generate a new index mark; second determining means 263 for further determining whether this mark is stored within the length range of the index mark queue; first storing means 264 for, responsive to the determination by the second determining means that said mark is stored within the length range, storing the newly generated index mark according to the first strategy; and second storing means 265 for, responsive to the negative determination by the second determining means, storing the newly generated index mark based on the FIFO principle and said first strategy.

With respect to the second exemplary case, the operations by the index mark manager are as shown in FIG. 5B. The operations shown in FIG. 5B are substantially the same as those shown in FIG. 5A and their differences are described below. In the process shown in FIG. 5B, in order to enable the storing sequence of the index marks to be consistent with the sequence in which the user browses a document, it is necessary to mark all the views in which a content jump occurs (irrespective of whether they were previously marked), so certain operations (e.g., those depicted by process block 555 and process block 560 as shown in FIG. 5A) have been omitted. Additionally, the newly generated index mark is stored into the end of the queue according to the second strategy. Thereafter, the process shown in FIG. 5B ends (process block 585).

In accordance with the case shown in FIG. 5B, it is possible for the index mark manager not to comprise first determining means 262 but rather to comprise second determining means 263 for further determining whether the generated index mark is stored within the length range of the index mark queue; first storing means 264 for, responsive to the determination by the second determining means that said mark is stored within the length range, storing the newly generated index mark according to the second strategy; and second storing means 265 for, responsive to the negative determination by the second determining means, storing the newly generated index mark based on the FIFO principle and said second strategy.

In the foregoing descriptions, when the storage of the new index mark results in the excess of the length of the index mark queue, the new index mark is stored by deleting the earlier index mark based on the FIFO principle, in alternative embodiments however all original index marks may be reserved without storing the new index mark.

Furthermore, if the user deletes fragments of content during browsing the content, some index marks may be caused to be deleted, and at this time, the index mark manager may delete these index marks or direct the index marks to the closest position to the deleted content.

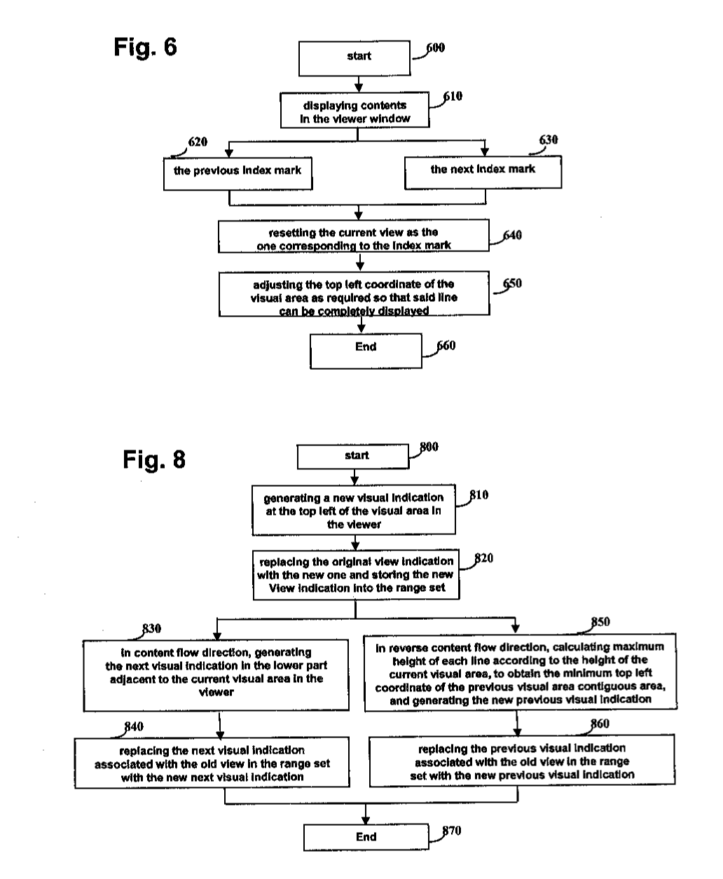

A user's operations of navigating through the content by using an index mark queue are described below with reference to FIG. 6.

The system according to the present invention further provides navigating means 280, as shown in FIG. 2A, for a user's navigation by switching among respective index marks. A representative form of such a navigating means is a navigation button displayed on the user interface, as shown by the leftward and rightward arrows 50, 60 in the toolbar in FIGS. 7A-7F. When no index mark has been generated, such arrows are grayed in one embodiment to show the unavailability of the navigating means; and after an index mark is generated, the navigating means becomes usable and the arrows are placed in an active state for the user's selection.

The process shown in FIG. 6 begins (process block 600) and thereafter a user views content in a content viewer window and some index marks have been generated (process block 610). Next, the user, by pressing a button (leftward arrow 50) representing the previous index mark (process block 620) or by pressing a button (rightward arrow 60) representing the next index mark (process block 630), expects to reach a marked position to browse the corresponding contents. Thus, responsive to the user's operation which specifies an index mark, the navigating means finds the information (e.g., the position, portion or page number, etc.) of the index mark so as to re-set the current view as the one corresponding to the index mark (process block 630).

When the view is re-set, the case where the first line of the reset view fails to be completely displayed may occur, such as only ⅓ of the first line being displayed. In this case, the height of the line can be adjusted (process block 650) so that the line can be completely displayed. Subsequently, the process shown in FIG. 6 ends (process block 660).

To carry out the operations shown in FIG. 6, system embodiments according to the present invention further comprise resetting means 281 for, responsive to the index mark specified by navigating means 280, resetting the current view as the one corresponding to the index mark; and adjusting means 282 for, if the first line of the reset view fails to be completely displayed, adjusting the top left coordinate of the visual area so that the first line can be completely displayed.

FIGS. 7A-7F are GUI examples illustrating use of systems and methods according to one or more embodiments of the present invention. In the illustrated embodiment of FIG. 7A, operations are depicted in which a user is viewing contents in a viewer window 700 as shown. The toolbar of viewer window 700 includes leftward and rightward arrows 50, 60 representing the index marks according to the present invention. The sequence of the index marks is consistent with the sequence of the text content, so in FIGS. 7A-7F, the leftward arrow 50 represents an index mark in the direction of reverse content flow, while the rightward arrow 60 represents an index mark in the direction of content flow (however, the sequence of the index marks can be consistent with the sequence in which the user generates an index mark). Since no index mark is currently generated in the content, leftward and rightward arrows 50, 60 are both grayed, which indicates the unavailability of index mark navigation. In FIG. 7A, the current view of viewer window 700 displays a fragment 20 of content, the last line of this fragment is indicated by an arrow 21, and the user can view subsequent text content by pressing a button 22.

FIG. 7B shows the case where the user views subsequent text content in the interface shown in FIG. 7A by pressing button 22. By comparing the views of FIGS. 7A and 7B, it can be seen that a scrollbar 29 moves the displayed area downwards so that some contents are moved off the display screen, some contents (sign 23) are kept displayed on the display, and some contents (sign 24) moves onto the display screen. An arrow 25 indicates the position of the visual indication of the current view, an arrow 26 is for indicating a text flow direction, and arrows 27 and 28 distinguish fragments 23 and 24 of the content. In the illustrated embodiments, as no index mark has been generated, arrows 50, 60 representing the index marks are kept grayed.

FIG. 7C shows the case where the user passes some contents by dragging the scrollbar 29 in the view shown in FIG. 7B and jumps to another fragment 30 of the text content. Due to the jump, some contents are neglected or passed and the displayed contents from the view shown in FIG. 7B to that shown in FIG. 7C are not contiguous, so an index mark will be generated for the view shown in FIG. 7B. Thus, the leftward arrow 50 in the toolbar shown in FIG. 7C becomes active from grayed while the rightward arrow 60 remains grayed and inactive. In FIG. 7C, an arrow 32 indicates the position of the top left coordinate of the view or the position of the visual indication of thereof, and an arrow 33 indicates the last line of the displayed contents.

The interface shown in FIG. 7D shows the case where the user continues to view the text following FIG. 7C. An arrow 34 indicates the position of the top left coordinate or the position of the visual indication in the view, an arrow 35 indicates the text flow direction and arrows 36 and 37 indicate the division between the contents in FIGS. 7C and 7D.

Since the viewing of FIG. 7C to FIG. 7D is the viewing of consecutive views, embodiments of the present invention will record a new position 34 of the top left coordinate or of the visual indication of the view so as to generate a new range of content, but no new index mark will be generated.

FIG. 7E shows the case where the user, by pressing leftward arrow 50 in the interface displayed in FIG. 7D, jumps back to the displayed content in FIG. 7B via the index mark. Since some contents are passed due to the jump, a new index mark will be generated for the view of FIG. 7D. Thus, the rightward arrow 60 in the toolbar in FIG. 7E becomes active and therefore no longer gray, while leftward arrow 50 becomes gray and inactive. Additionally, in FIG. 7E, arrow 25 still indicates the position of the top left coordinate or the position of the visual indication of the view.

FIG. 7F shows the case where the user, by pressing rightward arrow 60 in the interface displayed in FIG. 7E, jumps back to the content displayed in FIG. 7D via an index mark.

Referring to the examples explained in connection with the GUI, it can be seen that users can easily mark in a document content blocks which they are interested in and switch and navigate among the content blocks by using the index mark.

For convenient illustration, FIGS. 7A-7F only show the case in which two index marks and two navigation buttons are included. However, it should be understood that the number of index marks and the number of navigation buttons (such as a button representing a jump direct to the first/last index mark) can be increased as required in alternative embodiments.

FIG. 8 is a flow chart of operations in which a new view generates a new content range according to an embodiment of the present invention. According to the illustrated embodiment, so long as a change between the new and old views takes place, range generating means 230 generates a new range of content for the new view so as to update the content range set for use of the subsequent handling. In other words, in the case where the change between the new and old views takes place but no content jump occurs, or the case where the content jump is determined to have occurred but an index mark has been generated for the old view, it is necessary to generate a new range of content for the new view. According to one preferred mode of the present invention, the generation of the new range of content includes the generation of a new visual indication.

The method shown in FIG. 8 begins (process block 800) and then a new visual indication is generated for the new view (process block 810). This can be realized by obtaining from applications the top left coordinate of the new view.

Subsequently, (process block 820) the visual indication associated with the old view in the content range set is replaced with the new visual indication for the new view. Thereafter, a visual indication is generated for the new view (process block 830 and process block 840) and the previous visual indication is generated for the new view (process block 850 and process block 860).

In the embodiment of FIG. 8, the next visual indication is generated in the lower part adjacent to the current visual area in the viewer (process block 830). As depicted using process block 840, the new next visual indication is used to replace the next visual indication associated with the old view in the content range set. As shown via process block 850, the previous visual indication is generated in the upper part adjacent to the current visual area in the viewer which may include calculating the maximum height of each line according to the height of the current visual area so as to obtain the minimum top left coordinate of the previous visual area contiguous with the current visual area and generate the new previous visual indication. In this way, the previous visual indication can be ensured to point to the position which enables the first line of the previous visual area to be completely displayed. Thereafter, the new previous visual indication is used to replace the previous visual indication associated with the old view in the content range set (process block 860).

The content range set is a basis for determining whether a content jump occurs. In one or more embodiments of the present invention, such a determination is executed according to the position of the visual indication stored in the content range set. However, the determination can also be executed according to other parameters such as portion, page number, etc. of the content, in the content range set. Besides the above information, the content range set further stores other information associated with the view such as the display ratio, and these parameters can be directly obtained from the applications. Subsequently, the process shown in FIG. 8 ends (process block 870).

In addition, range generating means 230 can be coupled to acquiring means 251 of detecting means 250 to obtain from the application the top left coordinate information of the new view. Range generating means 230 can further comprise first replacing means 231 for replacing the visual indication associated with the old view in the content range set with the new visual indication of the new view; second replacing means 232 for generating the next visual indication in the lower part adjacent to the current visual area in the viewer and replacing the next visual indication associated with the old view in the content range set with the new next visual indication; and third replacing means 233 for, in the upper part adjacent to the current visual area in the viewer, calculating the maximum height of each line according to the height of the current visual area to obtain the minimum top left coordinate of the previous visual area contiguous with the current visual area, generate the new previous visual indication and replace the previous visual indication associated with the old view in the content range set with the new previous visual indication.

As understood by those skilled in the art, the apparatus according to the present invention can be realized in a hardware mode, or realized by configuring or programming a conventional memory or logic circuit to perform the corresponding functions, or realized by the combination of thereof.

The principles of the present invention are explained above in connection with the text content. However, as understood by those skilled in the art, embodiments of the present invention are not limited to text-content implementations but equivalently applicable to the content of any type, such as various contents having a document structure (e.g., form, presentation, etc.), pictures, images, video contents, audio contents and other varied multimedia contents. For example, as to video contents, when the user passes some contents through time searching or chapter selection or other modes during the course of viewing the video contents, it is possible to impose index marks on the video contents by obtaining the time position, frame, chapter and other information of the viewed contents from the player so as to identify the fragments which the user takes interest in.

In another embodiment applicable to presentations, when a user passes some contents when viewing a presentation, it is possible to mark the page number of the presentation so as to easily return to the previously passed contents.

It can be seen that, when the present invention is applied to different types of contents, only the bases for determining whether a content jump occurs are different (that is, the content range information in the content range set varies over the type of the content) and the forms taken by the index mark are different. However, the fundamental ideas of how to mark the contents are consistent.

In addition, those skilled in the art will realize that the embodiments of the present invention can be provided in the form of method, system or a computer program product. Thus, the present invention can adopt the form of full-hardware embodiments, full-software embodiments or embodiments of the combination of hardware and software. The typical combination of hardware and software can be a universal computer system with a computer program, when the program is loaded or executed, the above method can be performed by controlling the computer system.

The present invention can be embedded into a computer program product, which comprises all the features which enable the described method to be implemented. Such a computer program product may be contained in one or more computer readable storage media (comprising but not limited to a disk storage, a CD-ROM, an optical memory and the like), and such computer readable storage media may have computer readable and executable codes contained therein.

The present invention is explained above with reference to the flow charts and/or block diagrams of the method, system and computer program product according to the present invention. Each block in the flow charts and/or block diagrams and the combination of the blocks therein can be obviously realized by computer program commands. These computer program commands can be supplied to a processor of a general purpose computer, a dedicated or “special-purpose” computer or processor, an embedded processor or other programmable data processing devices to produce a machine, so that the commands (through the processor of a computer or other programmable data processing devices) produces an apparatus for realizing the functions specified in one or more blocks in the flow charts and/or block diagrams.

These computer program commands can also be stored within memories of one or more computers, and each of the memories can direct the computer or other programmable data processing devices to function according to a specified mode of operation. Thus, the commands stored in the computer memories produce a manufacturing product which comprises commanding means for realizing the functions specified in one or more blocks in the flow charts and/or block diagrams.

The computer program commands can also be loaded to one or more computers or other programmable data processing devices so as to perform a series of process operations on a computer or other programmable data processing device, so that a computer-implemented process can be produced on each of these devices. Thus, the commands executed on these devices provide functionality corresponding to the process blocks specified in one or more blocks in the flow charts and/or block diagrams.

By referring to the illustrated embodiments and processes for carrying out the embodiments of present invention depicted and described herein, the principles of the present invention are explained above. However, such embodiments are only exemplary and should not be understood as limiting the present invention. Those skilled in the art will appreciate that modifications to the described embodiments may be made without departing from the broader spirit and scope of the present invention.

What is claimed is:

1. A method comprising
receiving a user request to perform a navigation of displayed contents in a viewer window;
determining if said navigation is associated with a content jump following a receipt of said user request;
generating an index mark in response to a determination that said navigation is associated with a content jump; and
storing said index mark within an index mark queue to facilitate user navigation utilizing contents thereof.

2. The method of claim 1, wherein
said request to perform a navigation comprises a request to navigate from an old view within said viewer window to a new view within said viewer window, and
said determining comprises
determining whether displayed contents of said new view and displayed contents of said old view differ; and
determining whether a difference between said displayed contents of said new view and said displayed contents of said old view produces a content jump in response to a determination that said displayed contents of said new view and said displayed contents of said old view differ.

3. The method of claim 2, wherein determining whether said displayed contents of said new view and said displayed contents of said old view differ comprises:
capturing an event associated with said difference between said displayed contents of said new view and said displayed contents of said old view; and
determining whether said displayed contents of said new view and said displayed contents of said old view differ utilizing said event.

4. The method of claim 2, wherein determining whether a difference between said displayed contents of said new view and said displayed contents of said old view produces a content jump comprises:
determining whether said difference exceeds a content range set defined for said old view.

5. The method of claim 4, wherein determining whether said difference exceeds a content range set defined for said old view comprises:
receiving calculated coordinate information of said new view from an application to generate a new visual indication for said new view; and
comparing said new visual indication to a previous visual indication of said old view and next visual indication of said old view utilizing said content range set of said old view, wherein comparing said new visual indication comprises:
determining whether said new visual indication is smaller than said previous visual indication or greater than said next visual indication.

6. The method of claim 1, wherein
generating said index mark comprises
determining whether said index mark is different from an existing index mark in said index mark queue, and generating said index mark in response to a determination that said index mark is different from said existing index mark; and
storing said index mark comprises
determining whether said index mark is stored within a length range of said index mark queue;
storing said index mark according to a first strategy in response to a determination that said index mark is stored within said length range, and
storing said index mark based on a FIFO storage principle and said first strategy in response to a determination that said index mark is stored outside of said length range.

7. The method of claim 1, wherein
generating an index mark in response to a determination that said navigation is associated with a content jump comprises generating a first index mark;
said method further comprises
generating a second index mark in response to a generation of said first index mark;
determining whether said second index mark is stored within a length range of said index mark queue;
storing said second index mark according to a second strategy in response to a determination that said index mark is stored within said length range, and
storing said second index mark based on a FIFO storage principle and said second strategy in response to a determination that said second index mark is stored outside of said length range.

8. The method of claim 1, wherein
receiving said user request to perform a navigation comprises receiving data specifying an input index mark, and
said method further comprises
resetting a current view as a view corresponding to said input index mark; and
adjusting a top left coordinate of a visual area of said current view to completely display a first line of said corresponding to said input index mark in response to a determination that said first line is not completely displayed subsequent to said resetting.

9. The method of claim 2, further comprising:
generating a new range of content for said new view to update a content range set in response to at least one of: a determination that said navigation is not associated with a content jump and a determination that an index mark has been previously-generated for said old view.

10. The method of claim 9, wherein generating said new range of content for said new view further comprises:
obtaining coordinate information of said new view;
replacing a visual indication associated with said old view in an associated content range set with a new visual indication of said new view;
generating a next visual indication associated with said new view in a lower area adjacent to a current visual area in said viewer window;
replacing a next visual indication associated with said old view in said associated content range set with said next visual indication associated with said new view;
calculating a maximum height of each line utilizing a height of said current visual area in an upper area adjacent to said current visual area in said viewer window, so as to obtain a minimum top left coordinate of a previous visual area which is contiguous with said current visual area and to generate a new previous visual indication, and
replacing a previous visual indication associated with said old view in said content range set with the new previous visual indication.

11. The method of claim 1, wherein the displayed contents comprise at least one of the following: text, form, presentation, pictures, images, video contents, and audio contents.

12. A system for facilitating user navigation through displayed contents via a viewer window, said system comprising:
means for receiving a user request to perform a navigation of displayed contents in said viewer window;
means for determining if said navigation is associated with a content jump following a receipt of said user request;
means for generating an index mark in response to a determination that said navigation is associated with a content jump; and
means for storing said index mark within an index mark queue to facilitate user navigation utilizing contents thereof.

13. The system of claim 12, wherein
said request to perform a navigation comprises a request to navigate from an old view within said viewer window to a new view within said viewer window, and
said means for determining comprises
means for determining whether displayed contents of said new view and displayed contents of said old view differ; and
means for determining whether a difference between said displayed contents of said new view and said displayed contents of said old view produces a content jump in response to a determination that said displayed contents of said new view and said displayed contents of said old view differ.

14. The system of claim 13, wherein said means for determining whether said displayed contents of said new view and said displayed contents of said old view differ comprises:
means for capturing an event associated with said difference between said displayed contents of said new view and said displayed contents of said old view; and
means for determining whether said displayed contents of said new view and said displayed contents of said old view differ utilizing said event.

15. The system of claim 13, wherein said means for determining whether a difference between said displayed contents of said new view and said displayed contents of said old view produces a content jump comprises:
means for determining whether said difference exceeds a content range set defined for said old view.

16. The system of claim 15, wherein said means for determining whether said difference exceeds a content range set defined for said old view comprises:
means for receiving calculated coordinate information of said new view from an application to generate a new visual indication for said new view; and
means for comparing said new visual indication to a previous visual indication of said old view and next visual indication of said old view utilizing said content range set of said old view, wherein said means for comparing said new visual indication comprises:
means for determining whether said new visual indication is smaller than said previous visual indication or greater than said next visual indication.

17. The system of claim 12, wherein
said means for generating said index mark comprises
means for determining whether said index mark is different from an existing index mark in said index mark queue, and for generating said index mark in response to a determination that said index mark is different from said existing index mark; and
said means for storing said index mark comprises
means for determining whether said index mark is stored within a length range of said index mark queue;
means for storing said index mark according to a first strategy in response to a determination that said index mark is stored within said length range, and
means for storing said index mark based on a FIFO storage principle and said first strategy in response to a determination that said index mark is stored outside of said length range.

18. The system of claim 12, wherein
said means for generating an index mark in response to a determination that said navigation is associated with a content jump comprises means for generating a first index mark;
said system further comprises
means for generating a second index mark in response to a generation of said first index mark;
means for determining whether said second index mark is stored within a length range of said index mark queue;
means for storing said second index mark according to a second strategy in response to a determination that said index mark is stored within said length range, and
means for storing said second index mark based on a FIFO storage principle and said second strategy in response to a determination that said second index mark is stored outside of said length range.

19. The system of claim 12, wherein
said means for receiving said user request to perform a navigation comprises
means for receiving data specifying an input index mark, and
said system further comprises
means for resetting a current view as a view corresponding to said input index mark; and
means for adjusting a top left coordinate of a visual area of said current view to completely display a first line of said corresponding to said input index mark in response to a determination that said first line is not completely displayed subsequent to said resetting.

20. The system of claim 13, further comprising:
means for generating a new range of content for said new view to update a content range set in response to at least one of: a determination that said navigation is not associated with a content jump and a determination that an index mark has been previously-generated for said old view.

21. The system of claim 20, wherein said means for generating said new range of content for said new view further comprises:
means for obtaining coordinate information of said new view;
means for replacing a visual indication associated with said old view in an associated content range set with a new visual indication of said new view;
means for generating a next visual indication associated with said new view in a lower area adjacent to a current visual area in said viewer window;
means for replacing a next visual indication associated with said old view in said associated content range set with said next visual indication associated with said new view;
means for calculating a maximum height of each line utilizing a height of said current visual area in an upper area adjacent to said current visual area in said viewer window, so as to obtain a minimum top left coordinate of a previous visual area which is contiguous with said current visual area and to generate a new previous visual indication, and
means for replacing a previous visual indication associated with said old view in said content range set with the new previous visual indication.

22. The system of claim 21, wherein the displayed contents comprise at least one of the following: text, form, presentation, pictures, images, video contents, and audio contents.

24. A machine-readable storage medium having a plurality of instructions executable by a machine embodied therein, wherein said plurality of instructions when executed cause said machine to perform a method comprising:
receiving a user request to perform a navigation of displayed contents in a viewer window;
determining if said navigation is associated with a content jump following a receipt of said user request;
generating an index mark in response to a determination that said navigation is associated with a content jump; and
storing said index mark within an index mark queue to facilitate user navigation utilizing contents thereof.
